(19) United States
(12) Patent Application Publication
(10) Pub. No.: US 2023/0115424 A1
(43) Pub. Date: Apr. 13, 2023

(54) HIGH BARRIER CELLULOSIC STRUCTURE AND CELLULOSIC CONTAINER

(71) Applicant: WestRock MWV, LLC, Atlanta, GA (US)

(72) Inventors: Rahul BHARDWAJ, Glen Allen (VA); Chitai C. YANG, Glen Allen, VA (US); Justin L. BENNETT, Williamsburg, VA (US); Courtney JOHNSON, Midlothian, VA (US); Steven G. BUSHHOUSE, Quinton, VA (US); Meredith W. ALLIN, Richmond, VA (US)

(21) Appl. No.: 17/964,829

(22) Filed: Oct. 12, 2022

Related U.S. Application Data
(60) Provisional application No. 63/254,921, filed on Oct. 12, 2021.

(51) Int. Cl. B65D 65/40; B65D 3/28

(52) U.S. Cl. CPC B65D 65/40; B65D 3/28; B65D 2565/387

(57) ABSTRACT

A cellulosic structure including a cellulosic board substrate, a metal oxide layer positioned over the cellulosic board substrate, and a tie layer between the cellulosic board substrate and the metal oxide layer.

### PRIORITY

This application claims priority from U.S. Ser. No. 63/254,921 filed on Oct. 12, 2021, the entire contents of which are incorporated herein by reference.

### FIELD

The present application relates to the field of high barrier cellulosic structures for cellulosic containers.

### BACKGROUND

Paper-based containers typically are formed from a blank, such as blank of paperboard. The paperboard blank is die cut to the desired silhouette and then the blank is formed into the desired container shape. For example, the blank may be wrapped around a mandrel to form a cylindrical or frustoconical container body. A bottom component is typically connected to the container body to enclose the lower end of the container body. After filling the container, a lid component is typically connected to the container body to fully enclose the container.

The contents of paper-based containers may be exposed to oxygen, moisture and light, which may penetrate through the walls of such containers. Depending on the contents of the container, oxygen, moisture and light penetration may result in product degradation. For example, foodstuffs may degrade much more quickly and, thus, may have a significantly shorter shelf life when packaged in containers that do not significantly exclude oxygen, moisture and light.

Thus, paper-based containers have been formed from material having barrier properties. For example, conventional paper-based containers typically have metallic barrier layers incorporated into paperboard blanks used to form containers for foodstuffs sensitive to degradation due to oxygen, moisture and light penetration. However, incorporation of the metallic barrier layers limits the recyclability of the paper-based containers.

There is a need for a new recyclable material that still has the same or similar barrier properties as these conventional paper-based containers that incorporate metallic barrier layers.

Accordingly, those skilled in the art continue with research and development in the field of high barrier cellulosic structures for cellulosic containers.

### SUMMARY

In one embodiment, a cellulosic structure includes a cellulosic board substrate, a metal oxide layer positioned over the cellulosic board substrate, and a tie layer between the cellulosic board substrate and the metal oxide layer.

In another embodiment, a cellulosic container includes a sidewall component having a first end and a second end, a bottom component enclosing the first end of the sidewall component, and a lid component enclosing the second end of the sidewall component. The sidewall component includes a cellulosic board substrate having an interior surface, a tie layer on the interior surface of the cellulosic board substrate, and a metal oxide layer on the tie layer.

Other embodiments of the disclosed cellulosic structures and cellulosic containers will become apparent from the following detailed description, the accompanying drawings and the appended claims.

### BRIEF DESCRIPTION OF THE DRAWINGS

FIG. 1 is an illustration of a representation of an exemplary cellulosic structure according to an embodiment of the present description.

FIG. 2 is an illustration of an exemplary sidewall component of an exemplary cellulosic container according to an embodiment of the present description.

FIG. 3 is an illustration of an exemplary cellulosic container according to an embodiment of the present description.

FIG. 4 is a graphical depiction of Transmittance (% T) for four trial samples for four cellulosic substrates.

FIG. 5 is a graphical depiction of Transmittance (% T) for four trial samples for four coated cellulosic structures.

### DETAILED DESCRIPTION

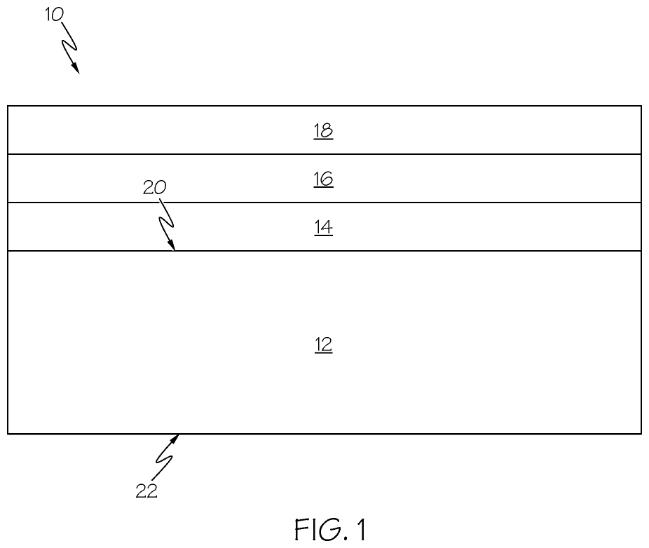

Referring to FIG. 1, one embodiment of the disclosed cellulosic structure 10 may include a cellulosic board substrate 12, a tie layer 14 on the cellulosic board substrate 12; a metal oxide layer 16 on the tie layer 14; and an optional heat seal layer 18 on the metal oxide layer 16. Additional layers may be included in the disclosed cellulosic structure 10 without departing from the scope of the present disclosure.

The cellulosic board substrate 12 may have a low average and/or maximum Transmittance in a UV-visible light spectrum. In an aspect, the average Transmittance (% T) in a range of 200-800 nm is 2.5% or less, such as 1.6% or less, 1.1% or less, 0.7% or less, 0.5% or less, 0.3% or less, or 0.1% or less. In another aspect, the maximum Transmittance (% T) in a range of 300-700 nm of 4.0% or less, such as 3.0% or less, 2.0% or less, 1.0% or less, 0.5% or less, or 0.3% or less. The average and maximum Transmittance is tested at 23 degrees Celsius. Thus, the cellulosic board substrate having low average and/or maximum Transmittance contributes to resistance against light penetration into a container formed therefrom that may result in product degradation. The average and maximum Transmittance of the cellulosic board substrate may result from a combination of factors, including lignin content of the cellulosic board substrate, caliper thickness of the cellulosic board substrate, and basis weight of the cellulosic board substrate. By reducing the average and/or maximum Transmittance of the cellulosic board substrate, the cellulosic board substrate of the present application may eliminate or reduce the requirement for other means for resisting against light penetration.

In an aspect, the cellulosic board substrate 12 may have a lignin content of 2% or more, by weight, such as 4% or more, 6% or more, 8% or more, 10% or more, 12% or more, 14% or more, 16% or more, or 18% or more. The lignin content of the cellulosic board substrate contributes to resistance against light penetration into a container formed therefrom that may result in product degradation. The lignin may act as chromophore which functions as a light barrier. By increasing the lignin content of the cellulosic board substrate, the maximum Transmittance of the cellulosic board substrate is reduced.

In an aspect, the cellulosic board substrate 12 may have a basis weight in a range of 180 to 290 pounds per 3000 ft², such as 210 to 260 pounds per 3000 ft². In an example, a 20 pt. board may be used having a basis weight of 240 pounds per 3000 ft². The basis weight of the cellulosic board substrate contributes to resistance against light penetration into a container formed therefrom that may result in product degradation. By increasing the basis weight of the cellulosic board substrate, the maximum Transmittance of the cellulosic board substrate is reduced. In other aspects, the basis weight of the of the cellulosic board substrate may be less than 180 pounds per 3000 ft² or greater than 290 pounds per 3000 ft².

In an aspect, the cellulosic board substrate 12 may have a caliper thickness in a range of 10 to 36 points, such as 14 to 30 points or 18 to 22 points. The caliper thickness of the cellulosic board substrate contributes to resistance against light penetration into a container formed therefrom that may result in product degradation. By increasing the caliper thickness of the cellulosic board substrate, the maximum Transmittance of the cellulosic board substrate is reduced. In other aspects, the caliper thickness of the of the cellulosic board substrate may be less than 14 points or greater than 30 points. The caliper thickness of the cellulosic board substrate may depend on various factors, such as the density of the cellulosic board substrate. As used herein, 1 point equals 0.001 inches, which equals 25.4 micrometers (μm).

The cellulosic board substrate 12 may include or be, for example, a paperboard substrate.

In an aspect, the tie layer 14 may include or be polyolefin, such as low density polyethylene. The tie layer 14 may be melt extruded at high temperature to connect the metal oxide layer 16 to the cellulosic board substrate 12. In another aspect, the tie layer 14 may include or be, for example, an adhesive.

In an aspect, the metal oxide layer 16 functions as a barrier layer to oxygen and moisture. As one specific example, metal oxide layer 16 may include or be a metal oxide coated substrate, such as a metal oxide coated paper or a metal oxide coated polymer. In the case of the metal oxide coated polymer, the metal oxide coated polymer may include or be, for example, an aluminum oxide coated polymer. As another specific example, the metal oxide coated polymer may include or be a silicon oxide coated polymer. In an aspect, the polymer of the metal oxide coated polymer may include or be a polyester or polyolefin. In another aspect, the polymer of the metal oxide coated polymer may include or be polyethylene terephthalate. The presence of the metal oxide coated polymer facilitates the resistance to the passage of oxygen and moisture to the interior of a container formed from the cellulosic structure 10. However, the metal oxide coated polymer may be transparent and not prevent the passage of light. Therefore, the combination of the cellulosic board substrate 12 and the metal oxide coated polymer provides for resistance to the passage of oxygen, moisture, and light to the interior of a container formed from the cellulosic structure 10.

The disclosed metal oxide coated polymer may be formed by coating a polymer (e.g., polyethylene terephthalate) film with the metal oxide. The metal oxide coated polymer may be selected from commercially available metal oxide coated polymers from a variety of sources.

In an aspect, the metal oxide coated polymer may be applied by an extrusion lamination process. For example, a transparent high barrier aluminum oxide (AlOx) or silicon oxide (SiOx) coated polyester film may be laminated to cellulosic board substrate with a family of polyolefins homopolymer, co-polymers, terpolymers and their functionalized and modified forms. Similar materials or their combinations can be used as an overcoat heat seal layer.

In an aspect, the optional heat seal layer 18 may include or be, for example, low density polyethylene. In another aspect, the heat seal layer 18 may include or be, for example from a family of polyolefins homopolymer, co-polymers, terpolymers, and their functionalized and modified forms. In other expressions, the heat seal layer 18 may be formed from other materials capable of being activated, such as with heat, ultrasonic energy, radiation or the like, to form a seal. Combinations of sealing materials may be used to form the heat seal layer 18. In a specific examples, the heat seal layer 18 may include monolayer or co-extruded structures.

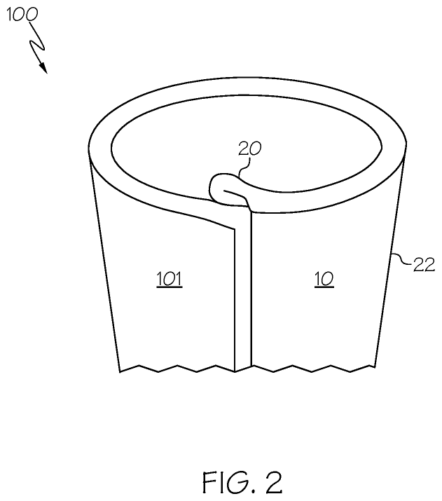

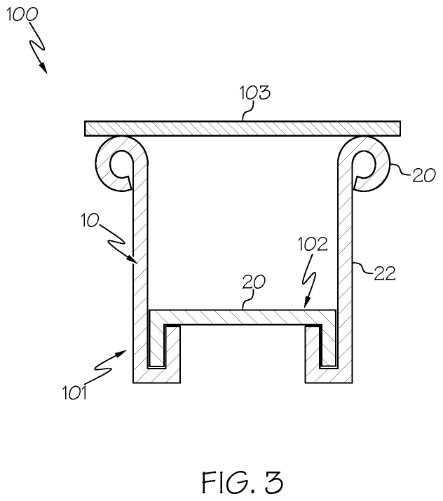

Referring to FIGS. 2 and 3, also disclosed is a container 100 formed from the cellulosic structure 10. In one expression, the container 100 includes a sidewall component 101 having a first end and a second end, a bottom component 102 enclosing the first end of the sidewall component, and a lid component 103 enclosing the second end of the sidewall component. The sidewall component includes a cellulosic board substrate 12 having an interior surface, a tie layer 14 on the cellulosic board substrate, a metal oxide layer 16 on the tie layer, and an optional heat seal layer 18 on the metal oxide layer.

The sidewall component 101 may be formed by, for example, die-cutting a sheet of the disclosed cellulosic structure 10 (FIG. 1) to form a blank having the desired silhouette (e.g., trapezoidal or rectangular). Then the blank may be formed into the desired sidewall component shape. For example, the blank may be wrapped around a mandrel to form a cylindrical or frustoconical sidewall component 101. The heat seal layer 18 may be activated to seal together the sidewall component 101. The bottom component 102 is typically connected to the sidewall component 101 to enclose the lower end of the sidewall component 101. After filling the container, the lid component 103 is typically connected to the sidewall component 101 to fully enclose the container. The heat seal layer 18 may be activated to seal together the sidewall component 101, the bottom component 102, and the lid component 103. The bottom component 102 or the lid component 103 may be formed from the disclosure cellulosic structure 10 or may be formed from a different material.

The cellulosic structure 10 may have a low average and/or maximum Transmittance in a UV-visible light spectrum. In an aspect, the cellulosic structure 10 may have an average Transmittance (% T) in a range of 200-800 nm is 1.0% or less, such as 0.5% or less, 0.3% or less, 0.2% or less, 0.1% or less, 0.05% or less, 0.02% or less, or 0.01% or less. In another aspect, the cellulosic structure 10 may have a maximum Transmittance (% T) in a range of 300-700 nm of 1.0% or less, such as 0.5% or less, 0.3% or less, 0.2% or less, 0.1% or less, or 0.05 or less. The average and/or maximum Transmittance of the cellulosic structure may be controlled by decreasing the average and/or maximum Transmittance of the cellulosic board substrate or by other means for resisting against light penetration. By reducing the average and/or maximum Transmittance of the cellulosic structure 10 a content of a container formed therefrom may be protection from degradation due to light. By reducing the average and/or maximum Transmittance of the cellulosic structure 10, the present description can eliminate the use of metal foil or pigments such as carbon black, thus providing for a recyclable high barrier cellulosic structure for forming cellulosic containers.

In another aspect, the cellulosic structure may have an oxygen transmission rate of less than 0.1 cc/m2/day at 1 atm. In another aspect, the cellulosic structure may have a moisture vapor transmission rate of less than 0.1 g/m2/day.

In another aspect, the cellulosic structure 10 may have at least 80%, by weight, cellulosic content, such as has at least 85%, by weight, cellulosic content, or at least 90%, by weight, cellulosic content. A reminder of the cellulosic structure may include or be the tie layer, the metal oxide coated polymer, and the heat seal layer, or additional coating layers. By increasing the cellulosic content of the cellulosic structure 10, the average and/or maximum Transmittance (% T) in a UV-visible light spectrum may be reduced.

In an aspect, the cellulosic structure 10 may be formed by an extrusion lamination process.

FIGS. 2 and 3 are illustrations of an exemplary cellulosic container 100 according to an embodiment of the present description. The cellulosic container 100 includes a sidewall component 101 having a first end and a second end, a bottom component 102 enclosing the first end of the sidewall component, and a lid component 103 enclosing the second end of the sidewall component. The sidewall component 101 includes a cellulosic board substrate 12 having an interior surface 20 and an exterior surface 22, a tie layer 14 on the interior surface 20 of the cellulosic board substrate 12, a metal oxide layer 16 on the tie layer 14, and an optional heat seal layer 18 on the metal oxide layer 16. In an aspect, a food item susceptible to light induced degradation is sealed inside in the cellulosic container 100.

Testing around light barrier functionality of cellulosic substrate having different lignin contents was conducted, in particular for paperboard. Testing included testing of light barrier and Kappa number. Lignin content (weight percentage) was calculated from Kappa number using the following equation: Lignin level (wt. %)=Kappa number×0.13. It is referenced from standard ‘Kappa number of pulp TAPPI/ANSI T 236 om-13’. Kappa number is a key test method for determining the level of lignin remaining in a sample of finished or in process pulp. Kappa number gives the maker of the pulp, as well as the papermaking user of the pulp, valuable information about the properties of the pulp as well as the paper made from it, particularly regarding the level of residual lignin present.

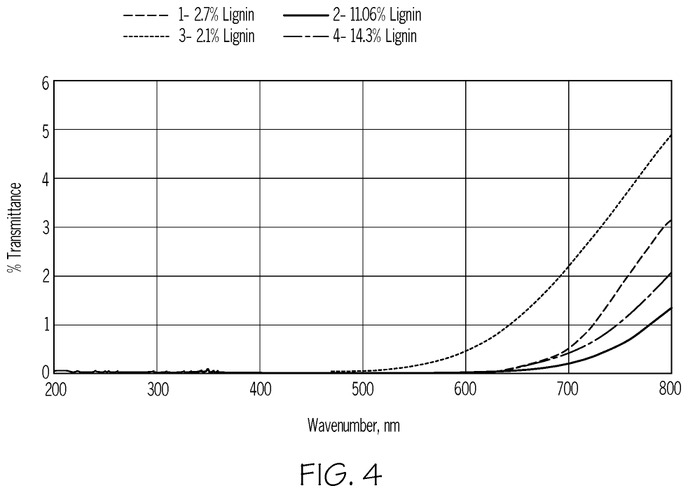

In the present description, it is disclosed that the amount of lignin and caliper of board plays a key role in providing the light barrier. It is also found that the formation of board plays a key role as well. Following Table 1 and the graph of FIG. 4 depict that behavior of the paperboard.

TABLE 1

| Sample | | grammage, | Caliper, | density, | Kappa | Lignin | Avg. % T, |
|---|---|---|---|---|---|---|---|
| ID | Board Type | gsm | inches | kg/m\hat{ }3 | Number | [%] | 200-800 nm |
| 1 | Natural Kraft | 254 | 0.0148 | 746 | 21.4 | 2.78 | 1.59 |
| 2 | Natural Kraft | 254 | 0.0165 | 746 | 85.1 | 11.06 | 0.66 |
| 3 | Natural Kraft | 224 | 0.0147 | 702 | 16.2 | 2.11 | 2.47 |
| 4 | Natural Kraft | 254 | 0.0148 | 634 | 110.1 | 14.31 | 1.05 |

The above Table 1 shows that the board having least lignin has highest transmittance, while the similar thickness boards having higher lignin content provide less transmittance hence better light barrier. The data also shows that combination of higher caliper and high lignin provides even better light barrier, as shown by sample IDs 2 and 4.

The graph of FIG. 4 below shows the entire % T curve in wavenumber from 200-800 nm which falls in UV-Visible spectrum. This illustrate that the appropriate board with certain thickness and lignin content can act as an effective barrier to UV and light. As previously description, such board substrates can be used for barrier lamination and coating to develop paperboard based material that can be used for application where moisture, oxygen and light barrier are needed to form a cellulosic structure comprising the board substrate and the coatings of the present description formed thereon.

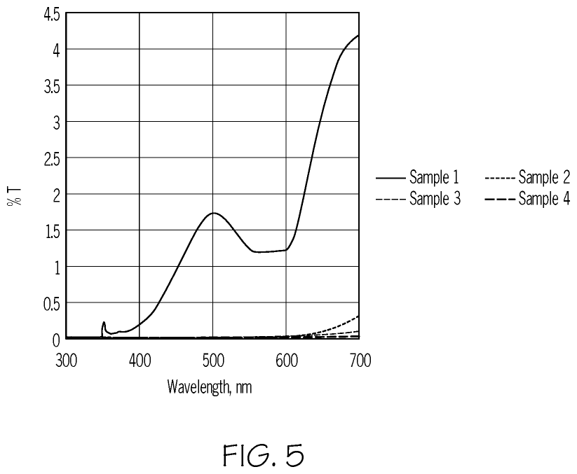

FIG. 5 shows light transmission results for different cellulosic substrates with transparent barrier films. Specifically, FIG. 5 shows the maximum Transmittance (% T) in a range of 300-700 nm for four trial samples. Table 2 below shows oxygen transmission rates (OTR), moisture vapor transmission rates (MVTR), light transmission results, and paperboard content (in % by weight) for four different trial samples.

TABLE 2
Experimental Results

| | | OTR, cc/m²/day | | Light Barrier, | |
|---|---|---|---|---|---|
| | Barrier | @23° C., 50% RH | MVTR, g/m²/day | Avg. % T, | Paperboard |
| Board | Film | out, 0% RH in | @23° C., 75% RH | 200-800 nm | Content % |
| Coated | SiOx PET | 0.07 | 0.04 | 0.037 | 90.6 |
| Board 1 | AlOx PET | 0.07 | 0.07 | 0.034 | 90.6 |
| Coated | SiOx PET | 0.04 | 0.04 | 1.982 | 90.4 |
| Board 2 | AlOx PET | 0.09 | 0.22 | 1.625 | 90.4 |

The experimental results of FIG. 5 show that the higher lignin content substrate (Coated Board 1 in Table 2) acts as a significantly better light barrier than the lower lignin content substrate (Coated Board 2 in Table 2). Coated Board 1 is a coated kraft board, while Coated Board 2 is a coated bleached board. Thus, these experimental results show that the properties of the cellulosic substrate may be selected to either provide or contribute to the light barrier requirements of a container for holding light sensitive products therein to achieve low Transmittance for a cellulosic structure 10.

Although various embodiments of the disclosed high barrier cellulosic structures for cellulosic containers have been shown and described, modifications may occur to those skilled in the art upon reading the specification. The present application includes such modifications and is limited only by the scope of the claims.

1. A cellulosic structure, comprising:
a cellulosic board substrate;
a metal oxide layer positioned over the cellulosic board substrate; and
a tie layer between the cellulosic board substrate and the metal oxide layer.

2. The cellulosic structure of claim 1, wherein the cellulosic board substrate has an average Transmittance (% T) in a range of 200-800 nm of 2.5% or less.

3-8. (canceled)

9. The cellulosic structure of claim 1, wherein the cellulosic board substrate has a maximum Transmittance (% T) in a range of 300-700 nm of 4.0% or less.

10-14. (canceled)

15. The cellulosic structure of claim 1, wherein the cellulosic board substrate has a lignin content of 2% or more, by weight.

16-28. (canceled)

29. The cellulosic structure of claim 1, wherein the tie layer comprises polyolefin.

30. The cellulosic structure of claim 1, wherein the tie layer comprises low density polyethylene.

31. The cellulosic structure of claim 1, wherein the tie layer comprises an adhesive.

32. The cellulosic structure of claim 1, wherein the metal oxide layer is a metal oxide coated substrate.

33. The cellulosic structure of claim 32, wherein the metal oxide layer comprises at least one of aluminum oxide and silicon oxide.

34. The cellulosic structure of claim 32, wherein the metal oxide coated substrate is a metal oxide coated polymer.

35. The cellulosic structure of claim 34, wherein the metal oxide coated polymer comprises at least one of polyester or polyolefin.

36. The cellulosic structure of claim 34, wherein the metal oxide coated polymer comprises polyethylene terephthalate.

37. The cellulosic structure of claim 1, further comprising a heat seal layer positioned over the metal oxide layer.

38. The cellulosic structure of claim 37, wherein the heat seal layer comprises low density polyethylene.

39. The cellulosic structure of claim 37, wherein the heat seal layer comprises ethylene methyl acrylate (EMA).

40-47. (canceled)

48. The cellulosic structure of claim 1, wherein the cellulosic structure has a maximum Transmittance (% T) in a range of 300-700 nm of 1.0% or less.

49-53. (canceled)

54. The cellulosic structure of claim 1, wherein the cellulosic structure has at least 80%, by weight, cellulosic content.

55-56. (canceled)

57. The cellulosic structure of claim 1, wherein the cellulosic structure has an oxygen transmission rate of less than 0.1 cc/m2/day at 1 atm.

58. The cellulosic structure of claim 1, wherein the cellulosic structure has a moisture vapor transmission rate of less than 0.1 g/m2/day.

59. A cellulosic container, comprising:
a sidewall component having a first end and a second end, the sidewall component comprising:
a cellulosic board substrate having an interior surface;
a tie layer on the interior surface of the cellulosic board substrate; and
a metal oxide layer on the tie layer;
a bottom component enclosing the first end of the sidewall component; and
a lid component enclosing the second end of the sidewall component.

60-117. (canceled)
